(19) United States
(12) Patent Application Publication
(10) Pub. No.: US 2026/0097916 A1
(43) Pub. Date: Apr. 9, 2026

(54) APPLICATION DEVICE HAVING REFILLING CASSETTE

(71) Applicant: TESA SE, Norderstedt (DE)

(72) Inventors: Lukas HERBST, Norderstedt (DE); Deniz Nick AKIN, Norderstedt (DE); Alexander MEISTER, Norderstedt (DE); Joachim MARTEL, Göttingen (DE)

(73) Assignee: TESA SE, Norderstedt (DE)

(21) Appl. No.: 19/115,544

(22) PCT Filed: Sep. 29, 2023
(86) PCT No.: PCT/EP2023/077185

§ 371 Date: Mar. 26, 2025

(30) Foreign Application Priority Data
Sep. 30, 2022 (DE) 10 2022 125 422.4

(51) Int. Cl. B65H 5/22; B65H 19/12

(52) U.S. Cl. CPC B65H 5/224; B65H 19/12; B65H 2405/42; B65H 2406/34; B65H 2701/19

(57) ABSTRACT

Application devices and methods are disclosed herein for applying adhesive elements and have a) a cassette unit comprising: a1) a guide arrangement having a supply roller and a receiving roller; a2) an issuing region having a dispensing edge; a3) a material strip having a number of adhesive elements. The devices and methods also have b) a base unit comprising: b1) a cassette receptacle; b2) a conveyor element having an adhesion-reduced surface; and b3) an application element.

The invention relates to an application device for applying adhesive elements to substrates to be adhesively bonded, to a cassette unit as well as to a base unit for a corresponding application device, and to a method for applying adhesive elements to substrates to be adhesively bonded, using a corresponding application device. Moreover disclosed is a method for loading a corresponding application device.

The use of adhesive elements nowadays is an important constituent part of many modern production methods. In the latter, corresponding adhesive elements are not only used for fastening components to a substrate, but also in particular serve for closing openings in a substrate. Such openings are in most instances present due to production circumstances and represent potential weak spots in the later product, by way of which moisture or contaminants can pass through, for example. The use of suitable adhesive elements, which are in most instances sticky on one side, for closing corresponding openings in substrates represents a simple solution, which is efficient in terms of time and costs, to close corresponding openings and to preclude any unintentional ingress of contaminants, wherein such adhesive elements which due to their production method are also referred to as punched blanks are already regularly used nowadays in the prior art for this purpose.

In principle, it is conceivable to place the corresponding adhesively elements manually on a substrate. However, in the course of increasing automation and an increased interest in a method management which is prone to as few errors as possible and is as efficient as possible, automation-capable application devices which serve to apply adhesive elements to a substrate to be adhesively bonded have been developed. A wide variety of requirements are set for corresponding application devices. For instance, corresponding application devices have to enable in particular a reliable and reproducible application of adhesive elements to the substrates, wherein it is desirable to achieve a high throughput rate.

One group of application devices known from the prior art is based on the concept that adhesive elements which are provided in a separate dispenser assembly, which is spaced apart from the application device, are picked up by the application device and placed on the substrate. However, this design embodiment is regularly perceived to be disadvantageous because it regularly requires a lot of installation space and in most instances necessitates a relatively spacious movement of the application elements when the latter are being moved in a reciprocating manner between the dispenser unit and the substrate to be adhesively bonded, this being perceived to be inefficient in many cases. Corresponding long motion paths increase the risk of faulty placements, for example due to shifting on the application element, and the risk of contaminants on the adhesive element, which may result in undesirable deteriorations of the achievable bonding strength.

Against this background, application devices having an integrated dispenser assembly for adhesive elements have been designed, in which the spacings between the provision of the adhesive element and the application device are very minor, so that both can be embodied as part of an end effector of a robotic head, for example.

Among these application devices having an integrated dispenser device for the adhesive elements, one of the greatest challenges lies in providing the adhesive elements, which in most instances are provided on a tape-shaped separation layer by a roll, reliably in such a manner that these adhesive elements can be reliably received and precisely applied by the actual application element of the application device. In practice, this represents a great challenge, the reason therefor being in particular that a concept with refill cassettes should expediently be considered for supplying corresponding application devices, in order to enable rapid filling of the application device with new adhesive elements. The reversible and non-destructive replacement capability of the reservoir of adhesive elements desired for this purpose makes it difficult to suitably present the adhesive elements provided on the tape-shaped separation layer to the actual application element, the latter per se expediently not to be part of the replaceable cassette. Accordingly, in order to implement an advantageous application device which can be fed with adhesive elements by means of a refill cassette, a suitable mechanism is required for the interaction between the cassette unit and the base unit supporting the application element.

In order to solve the problem, a construction which is based on the concept of a so-called reciprocating dispensing edge has been in particular proposed. The cassette herein comprises a movable element which can be deployed from the cassette and retracted into the latter again for the purpose of guiding the tape-shaped separation layer out of the cassette and as a result to present the adhesive element disposed on the tape-shaped separation layer to an application element outside the cassette, so that the adhesive element can be received by this application element and can ultimately be applied to a substrate.

While positive results can be achieved by corresponding constructions with a reciprocating dispensing edge in many cases, the complexity associated with the implementation, in particular in terms of the design embodiment of the refill cassette, is regularly perceived as disadvantageous. Not only is an additional drive thus required for moving the reciprocating dispensing edge, but in many cases a highly complex guide assembly having numerous guide units, for example guide rollers, is also required, the latter sometimes also having to be designed as movable web-tensioning elements in order to compensate for the periodic deformation of the tape-shaped separation material due to the reciprocating dispensing edge. Accordingly, the complexity associated with the production of corresponding refill cassettes is relatively high, and in the case of consumed refill cassettes there is a comparatively large amount of waste produced, unless these refill cassettes are topped up again, which is difficult in many cases due to the complexity of the construction.

As a consequence of the high level of complexity associated with corresponding constructions having a reciprocating dispensing edge, attempts have been made to provide alternative solution concepts. An exemplary solution concept is disclosed in EP 3569534 A1. The approach taken in EP 3569534 A1 is not disclosed in the context of a solution based on a refill cassette and is also not optimally suitable therefor according to the opinion of the inventors. However, EP 3569534 A1 shows a solution without a reciprocating dispensing edge, in which the punched blanks are instead transferred via a stationary dispensing edge to a revolving suction belt, wherein the adhesive face points outward. The adhesive elements, by way of the non-adhesive side, are held on the suction belt by a vacuum and guided about the latter until they lie on the tip of the suction belt, from where they are adhesively bonded on a hole, for example. In this solution, the suction belt therefore represents the application element, so to speak, which is to perform the final attachment of the adhesive element to the substrate.

While the solution disclosed in EP 3569534 A1 enables a simplification in terms of the construction of the dispenser assembly in comparison to a reciprocating dispensing edge, according to the opinion of the inventors the solution is still associated with noticeable disadvantages which are obstacles to an efficient implementation in a product having a replaceable refill cassette. It is perceived to be disadvantageous in particular that the adhesive elements are firmly held on the revolving suction belt exclusively by the suction function, so that a sufficient suction effect has to be ensured at all times, in particular in the case of a moving application device. A significant investment in equipment is necessary for this purpose, for example in terms of the perforation of the suction belt and of the apparatuses required for generating the vacuum, such as pumps and hose systems, for example. A corresponding design embodiment having a suction belt cannot be dispensed with even in the case of simple stationary application devices, because, for construction-related reasons, the application can only take place for such adhesive elements that are disposed on the lateral wall of the suction belt, this in any case requiring a suction effect. Moreover, no singularization of the adhesive elements takes place when transferring the latter to the actual application element in the solution of EP 3569534 A1, because the actual application element is formed by the revolving suction belt. Unless the spacing between the adhesive elements on the tape-shaped separation material is chosen to be uneconomically large, this leads to the situation in which a multiplicity of successively disposed punched blanks are suctioned onto the suction belt, which for the purpose of application is exposed, the adhesive layer of said punched blanks however already facing outward and thus being exposed. As a result, the application element per se is provided with a sticky surface, so to speak, which is not only disadvantageous for handling purposes but also carries the risk that the adhesive faces of the adhesive elements, which are lying open, are contaminated with dust or other components prior to being applied, and the achievable bonding strength upon application is disadvantageously influenced.

It is in some instances perceived to be an additional disadvantage that for ensuring a continuous flawless transfer of the adhesive elements from the dispensing edge to the revolving suction belt, the mutual spacing of these two elements must not vary. However, since a level of complexity in terms of construction that is comparable to the construction of a reciprocating dispensing edge is simultaneously to be avoided, the arrangement of the dispensing edge relative to the punched blank roll has also to be kept constant. However, if the application is to be effected by pressing an adhesive element suctioned onto the suction belt onto a substrate, as disclosed in EP 3569534 A1, but the suction belt, the dispensing edge and the roll receptacle are rigid relative to one another, this means that the suction belt as well as the dispensing edge and the punched blank roll have to be moved relative to the substrate in order to apply an adhesive element. Consequently, this means that a relatively large block, i.e., for example the entire end effector, has to be moved completely for each application step, wherein the punched blank roll, which in most instances weighs several kilograms, has to be moved in particular, this being an aspect which is perceived to be disadvantageous in many cases, in particular with a view to an increasing awareness in terms of energy-efficient operation.

The primary object of the present invention was to eliminate or at least minimize the above-described disadvantages of the prior art.

In particular, it was the object of the present invention to specify an advantageous application device for applying adhesive elements to substrates to be adhesively bonded, which enables an application of adhesive elements which is reliable and efficient in terms of time and costs.

The application device to be specified herein is to be able to be embodied with a replaceable refill cassette and nevertheless guarantee a reliable provision of adhesive elements from the refill cassette to the application element. In this context it was an object of the present invention that the application device to be specified is to be able to be operated using cassette units which are to be of a structurally particularly simple design and consequently able to be produced in a particularly time-efficient and cost-efficient manner.

It was an object of the present invention that the application device to be specified should be suitable for applying adhesive elements of different sizes without structural modifications, and moreover should permit the adhesive elements to be ideally densely packed on the material tape used for the supply, without having a disadvantageous effect on the precision of the application.

It was moreover an object of the present invention that the application device to be specified should be able to be operated with cassette units which are suitable particularly efficiently for refilling.

It was a further object of the present invention that the application device to be specified should be able to be operated in an ideally energy-efficient manner, wherein it should ideally be avoided that for the final application process the cassette unit has to be inevitably moved conjointly with the material roll as well.

It was moreover an object of the present invention that the application device to be specified in simple design embodiments should be able to be embodied even without complex apparatuses for generating a vacuum for temporarily fixing the adhesive elements, as is known from suction belts, for example. In this context, it was an additional object of the present invention that, if vacuum-based fixing is nevertheless utilized, a secondary fastening mechanism should advantageously be provided, which can at least partially compensate for potential fluctuations in the strength of the vacuum-based fixing.

Furthermore, it was an object of the present invention that the application device to be specified should guide the adhesive elements in such a way that the adhesive layer of the latter, provided for adhesively bonding to the substrate, is protected from contaminants for as long as possible.

It was a further object of the present invention to provide a cassette unit for use in the application devices to be specified, and corresponding base units for the application devices to be specified.

It was furthermore an object of the present invention to provide a method for applying adhesive elements to substrates to be adhesively bonded, using an application device to be specified.

It was a secondary object of the present invention to moreover provide a method for feeding an application device to be specified.

The inventors of the present invention have now found that the above-described objects can be achieved when an application device for applying adhesive elements to substrates to be adhesively bonded is provided, in which the cassette unit is disposed in the cassette receptacle of a base unit, when the adhesive elements disposed on a material tape are guided over a dispensing edge in the cassette unit so that said adhesive elements are separated from the separation material and are transferred with the adhesive layer facing downward onto a conveyor element of the base unit, which possesses a reduced-adhesion surface, so that the adhesive elements lying by way of the adhesive layer on the conveyor element can be received from the conveyor element by an application element of the base unit and applied to a substrate, as is defined in the claims.

The above-mentioned objects are thus achieved by the subject matter of the invention as defined in the claims. Preferred design embodiments according to the invention are derived from the dependent claims and from the explanations hereunder.

Such embodiments which are designated below as preferred are combined in particularly preferred embodiments with features of other embodiments designated as preferred. Especially preferred, therefore, are combinations of two or more of the embodiments designated below as particularly preferred. Likewise preferred are embodiments in which a feature of one embodiment, designated to some extent as preferred, is combined with one or more further features of other embodiments which are designated to some extent as preferred. Features of preferred cassette units, base units and methods are derived from the features of preferred application devices.

The invention relates to an application device for applying adhesive elements to substrates to be adhesively bonded, comprising:
a) a cassette unit comprising:
a1) a guide assembly comprising a supply roll and a take-up roll,
a2) a discharge region having a dispensing edge, and
a3) a material tape comprising a multiplicity of adhesive elements having a carrier layer and an adhesive layer connected thereto, wherein the adhesive elements with the adhesive layer are disposed on a web-shaped separation material,
   wherein the cassette unit is specified in such a way that the material tape provided on the supply roll can be guided by the dispensing edge to the take-up roll in such a manner that the adhesive elements are separated in the discharge region from the separation material and discharged from the cassette unit,
b) a base unit comprising:
b1) a cassette receptacle for receiving the cassette unit,
b2) a conveyor element having a reduced-adhesion surface, and
b3) an application element,
   wherein the base unit is specified to receive an adhesive element disposed on the conveyor element by the application element, and to apply said adhesive element to a substrate to be adhesively bonded, and
   wherein the cassette unit is disposed in the cassette receptacle so as to be replaceable in a reversible and non-destructive manner, wherein the application device is specified in such a way that an adhesive element with the adhesive layer, discharged from the cassette unit, is transferred to the reduced-adhesion surface of the conveyor element in such a way that the transferred adhesive element can be received from the reduced-adhesion surface of the conveyor element by the application element and be applied to a substrate to be adhesively bonded.

The application device according to the invention serves to apply adhesive elements to substrates to be adhesively bonded, wherein said application device is particularly suitable for applying so-called punched blanks in the automotive assembly sector. The application device according to the invention can be integrated in many ways into existing assembly lines in which adhesive elements have to be applied to substrates. For example, a largely stationary application device is conceivable, in which, for example, the application element in the context of a “pick & place” concept merely receives the adhesive elements provided from the cassette unit and places them on the substrate.

However, according to the opinion of the inventors, a design embodiment of the application device according to the invention, in which the latter is embodied as a so-called end effector, will be preferable for the large majority of cases. In accordance with the understanding by a person skilled in the art, an end effector is the executing and/or final element of automated motion units, for example robotic arms. In other words, in the field of robotics, end effectors are the last components of a kinematic chain, which are in most instances specified to carry out an execution rule predefined by an external control device, optionally conjointly with the automated motion unit to which they are fastened. Accordingly preferred is an application device according to the invention, wherein the application device is an end effector for an automated motion unit, preferably a robotic arm. Likewise preferable is an application device according to the invention, wherein the application device is disposed on an automated motion unit, preferably a robotic arm.

The person skilled in the art understands that the application device according to the invention comprises a multiplicity of automated, or automation-capable, components, in particular for moving the conveyor element, or the application element, and for guiding the material tape over the dispensing edge, for example by driving the rolls in the cassette unit. It is fundamentally possible here that this control, for example conjointly with the control of the automated motion unit, is performed by an external control device. However, according to the opinion of the inventors, it is advantageous when the application device according to the invention also comprises an internal electronic data processing device which can perform the control of one or a plurality of these components. Thus, an application device according to the invention is preferable, wherein the application device comprises an electronic data processing device for controlling the application device, preferably as a constituent part of the base unit.

The application device according to the invention firstly comprises a cassette unit which can also be referred to as a refill cassette. The task of this cassette unit in the application device according to the invention is to provide the adhesive elements to be applied to the application element of the base unit, wherein the person skilled in the art understands that the cassette unit of the application device according to the invention and the base unit are conceived in such a way that the cassette unit can be inserted into the cassette receptacle of the base unit so as to be reversible and replaceable in a non-destructive manner, which, according to the opinion of the inventors, can in particular be implemented by a magnetic connection. Consequently preferable is an application device according to the invention, wherein the cassette unit is disposed in the cassette receptacle so as to be reversible and releasable in a non-destructive manner by way of a magnetic connection mechanism.

In particularly preferred embodiments, wireless communication between the cassette unit and the base unit is possible, for example by corresponding transmitter/receiver systems, in particular by RFID, in order to verify an established connection between the cassette unit and the base unit. Advantageously, further data can moreover be exchanged by way of the wireless communication connection, for example the dimensions of the adhesive elements guided in the cassette unit, so that, for example, an application element of the base unit, which is suitable for the dimensions of the adhesive elements, can be selected for the application, or the speed control of the conveyor element can be adapted to the targeted singularization effect. Accordingly preferable is an application device according to the invention, wherein the application device comprises a wireless communication system, preferably a RFID system, the electronic communication units of the latter being disposed in the cassette unit and the base unit, wherein the application device is specified to control the application device as a function of operating parameters which are provided by the cassette unit by way of the wireless communication system, wherein the wireless communication system preferably serves to check the presence of the cassette unit in the base unit and/or to send operating parameters of the cassette unit to the electronic data processing device of the application device.

In the cassette unit, the individual adhesive elements as part of a material tape are disposed by way of the adhesive layer thereof on a web-shaped separation material, so that the carrier layer of the adhesive elements points outward. The adhesive elements will be described in more detail hereunder. At this point however, the construction of the cassette unit, i.e. of the refill cassette, firstly takes priority.

A central element of the cassette unit is the guide assembly in which the material tape is guided and which comprises a so-called supply roll and a take-up roll. In the unconsumed state, the supply roll comprises the wound material tape on which the adhesive elements are disposed, whereas the take-up roll is provided only for receiving the web-shaped separation material once the adhesive elements have been severed from the web-shaped separation material. In accordance with the understanding by the person skilled in the art, when carrying out the method according to the invention, or when operating the application device according to the invention, the web-shaped separation material is thus successively unwound from the supply roll, separated from the adhesive elements in the discharge region, and subsequently wound on the take-up roll, so that a completely consumed cassette unit in practice will in most instances comprise a web-shaped separation material which, except for a potential residual amount still connected to the supply roll, is substantially completely wound on the take-up roll. In other words, this is an application device according to the invention, wherein the cassette unit is specified to wind up the web-shaped separation material separated from the adhesive elements on the take-up roll.

Between the unwinding from the supply roll and the winding on the take-up roll, the material tape is guided over a dispensing edge, this taking place in a sub-region of the cassette unit which in the context of the present invention is referred to as the discharge region. The concept of a dispensing edge is well known to the person skilled in the art of adhesive bonding. The material tape with the web-shaped separation material and the adhesive elements disposed thereon is supplied onto the dispensing edge, wherein the web-shaped separation material at the end of the dispensing edge is guided sharply around this dispensing edge. As a consequence of the inherent stiffness of the adhesive element, which is greater than the adhesion on the web-shaped separation material, the adhesive element cannot follow this movement of the separation material and is instead successively released from the separation material the more the material tape is guided over the dispensing edge.

The corresponding region of the cassette unit here is presently referred to as the discharge region, because the adhesive element, which has been separated from the web-shaped separation material in this manner, is discharged from the cassette unit at this point and is transferred for further handling in the base unit, whereas the web-shaped separation material, which has now been relieved of the adhesive element, is guided onward in the direction of the take-up roll and correspondingly remains in the cassette unit.

It can be considered an advantage of the application device according to the invention that the latter is very flexible in terms of the design embodiment of the dispensing edge, so that the person skilled in the art can utilize assemblies which are known from the prior art and fulfil the function of separating the adhesive element from the web-shaped separation material. Preferable is, for example, an application device according to the invention, wherein the dispensing edge is a knife edge. In order to reduce potential frictional losses and consequently minimize the required motor output, it is preferable to use a radiused dispensing edge. Additionally or alternatively preferable is an application device according to the invention, wherein the cassette unit is specified to guide the material tape provided on the supply roll over the dispensing edge in such a manner that the web-shaped separation material is deflected by 90° or more at the end of the dispensing edge. The person skilled in the art understands that the actual deflection angle in practice will be dependent on the design embodiment of the dispensing edge, so that even deflection angles of 150° or more can be achieved, for example.

In this context, the person skilled in the art understands, however, that, with a view to the advantageous avoidance of a reciprocating dispensing edge and the associated structural design, a design embodiment is particularly preferable in which the dispensing edge is substantially in a fixed position, because particularly simple constructions which advantageously fully meet the functionality can be achieved in this way. Particularly preferable for substantially all design embodiments is thus an application device according to the invention, wherein the dispensing edge is immovable in the cassette unit, and/or wherein the dispensing edge is disposed in a fixed position in the cassette unit.

In light of the explanations above, it is clear to the person skilled in the art that the material tape, which is initially provided on the supply roll, has to be guided along the dispensing edge, or beyond the dispensing edge, in the direction of the take-up roll. For this purpose, it is fundamentally conceivable to provide a separate drive unit in the cassette unit, which can drive the supply roll and/or the take-up roll so as to enable the desired guiding of the material tape. In this context, the inventors however propose that equipping the cassette unit in this way with a drive unit, in particular when taking into account the energy sources required therefor, can lead to a significant increase in the constructive complexity in the design embodiment of the cassette units, as a result of which the efficiency in terms of time and costs in the production of the latter, and the required material need, are disadvantageously influenced. In order to circumvent this problem, the inventors propose that the rolls of the cassette unit can instead be embodied as non-driven rolls if a corresponding drive unit is provided in the base unit, which when inserting the cassette unit into the cassette receptacle of the base unit can engage in corresponding engagement recesses of the rolls by suitable connection elements in order to enable the driving of the guide assembly of the cassette unit by the drive unit of the base unit, so that the requirements in terms of the functionality and the construction of the cassette unit can advantageously be significantly reduced. It can be considered an advantage herein that mutually engaging connection elements and engagement recesses enable additional stabilizing of the cassette unit in the cassette receptacle of the base unit. Preferable is an application device according to the invention, wherein the supply roll and the take-up roll in the cassette unit are embodied as non-driven rolls. Preferable in this case is an application device according to the invention, wherein the base unit comprises a drive unit for driving the guide assembly of the cassette unit. Particularly preferred in this context is an application device according to the invention, wherein the supply roll and/or the take-up roll, preferably the supply roll and the take-up roll, comprise a central structured engagement recess, wherein the central structured engagement recess preferably has a toothed structure. Accordingly, particularly preferable is also an application device according to the invention, wherein the drive unit comprises one or a plurality of connection elements which are disposed in the region of the cassette receptacle and are specified to engage in the engagement recess of the supply roll and/or of the take-up roll and to generate a form-fitting connection which enables the driving of the guide assembly by the drive unit. In other words, particularly preferable is thus an application device according to the invention, wherein the cassette unit is disposed in the cassette receptacle in such a way that the connection elements of the drive unit engage in the engagement recess of the supply roll and/or of the take-up roll in a form-fitting manner, so that driving of the guide assembly by the drive unit is possible. In principle, the connection elements are not limited in terms of their design embodiment. However, according to the opinion of the inventors, connection elements having at least partially movable elements, for example foldable grippers or gripping devices based on movable ball elements, by way of which a form fit between the connection elements and the rolls can be achieved by displacing the movable elements, are particularly suitable. As a result, it is possible, for example, to insert the cassette unit into the base unit in a particularly simple manner in the initial position of the movable elements, and to only subsequently generate the engagement of the connection elements in the engagement recess required for driving by moving the movable elements.

Irrespective of the positioning of the drive unit used for guiding the tape, it is particularly advantageous according to the opinion of the inventors that the required guiding of the material tape in the cassette unit in application devices according to the invention can already be performed efficiently solely by the arrangement of the rolls in such a manner that a few stationary deflection elements can be utilized exclusively for guiding the material tape, so that no complex structures of movable guide installations, in particular no variable-position web-tensioning elements, are required in order to implement the required guiding of the material tape. Preferable is an application device according to the invention, wherein the guide assembly does not comprise any additional movable guide installations, in particular no additional guide rollers and/or movable web-tensioning elements.

At least theoretically, it is possible to embody the cassette unit as an open cassette unit in which the supply roll, the take-up roll and the dispensing edge are placed on a simple carrier plate, for example. However, this is perceived to be disadvantageous by the inventors not only from esthetic points of view. Instead, the adhesive elements lie at least partially open in these design embodiments, wherein the adhesive layer can also be accessible at least in the peripheral region. This can be considered disadvantageous with the view to a contamination of the punched blanks, or else with a view to the latter drying out. According to the opinion of the inventors it is advantageous for this purpose to instead provide a housing in which the substantial parts of the cassette unit are disposed in such a way that the latter are at least partially protected against environmental influences, for example light. A corresponding design embodiment proves to be advantageous in many cases also with a view to the handling as well as to the storage capability of the refill cassettes. Since the application element of the base unit has to receive the adhesive element, a design embodiment with a cassette unit having a housing in most instances means that the housing comprises a corresponding discharge opening in the region of the discharge region, by way of which discharge opening the adhesive element, which is separated from the web-shaped separation material, can be discharged from the housing. Preferable is an application device according to the invention, wherein the cassette unit comprises a housing in which the guide assembly and the dispensing edge are disposed, wherein the housing comprises a discharge opening in the discharge region, wherein the cassette unit is specified to discharge the adhesive elements through the discharge opening.

It can be considered an advantage of the application device according to the invention that the latter is suitable for applying a wide range of different adhesive elements. Because this is highly relevant in practice, the application of so-called punched blanks, in particular punched blanks having a diameter in the range from 10 to 80 mm, preferably in the range from 20 to 60 mm, is in particular of particular importance, wherein these are adhesive elements which can be obtained, for example, by punching the adhesive element out of a comparatively large adhesive unit, wherein the adhesive unit comprises an adhesive ply and a carrier ply disposed on the adhesive ply, from which the adhesive layers, or carrier layers of the adhesive elements result after the punching process. Preferable is thus an application device according to the invention, wherein the adhesive elements are punched blanks.

The person skilled in the art understands that the above definition means that the adhesive elements comprise at least one carrier layer and at least one adhesive layer, so that multiple-ply constructions of the adhesive elements are also conceivable. In particular, adhesive elements having multiple-ply carrier layers can be correspondingly also used.

The adhesive elements applied by application devices according to the invention in the method according to the invention will in the vast majority of cases be pressure-sensitive adhesive elements, i.e. adhesive elements which, due to an adhesive layer of a pressure-sensitive adhesive mass, possess permanently tacky properties. Corresponding pressure-sensitive adhesive elements are advantageously inherently sticky without any additional curing step, and can be particularly easily applied to substrates, wherein said pressure-sensitive adhesive elements develop their adhesive force without additional curing steps being required. As an additional advantage, pressure-sensitive adhesive elements can also be removed again in a comparatively simpler manner, however, if required, for example in order to subsequently correct the fit of an incorrectly applied pressure-sensitive adhesive element. Preferable is an application device according to the invention, wherein the adhesive elements are pressure-sensitive adhesive elements. Preferable is also an application device according to the invention, wherein the adhesive layer comprises a pressure-sensitive adhesive mass, wherein the adhesive layer preferably consists of a pressure-sensitive adhesive mass.

In accordance with the understanding of the skilled person, a pressure-sensitive adhesive mass is an adhesive mass which possesses pressure-sensitive adhesive properties, i.e. which possesses the property, even under relatively weak applied pressure, to enter into a durable bond to a substrate. Corresponding pressure-sensitive adhesive elements are in general already permanently inherently tacky at room temperature, meaning that they have a certain viscosity and touch-stickiness such that they wet the surface of a substrate even with a small applied pressure. Without wishing to be tied to this theory, it is frequently assumed that a pressure-sensitive adhesive mass may be regarded as a fluid of extremely high viscosity with an elastic component, which accordingly has characteristic viscoelastic properties that lead to the above-described durable inherent stickiness and pressure-sensitive adhesive bonding capacity. The assumption is that with corresponding pressure-sensitive adhesive masses, mechanical deformation results both in processes of viscous flow and in the development of elastic restoring forces. The viscous flow involved serves for the acquisition of adhesion while the elastic restoring forces involved are necessary in particular for achieving cohesion. The relationships between the rheology and the pressure-sensitive adhesiveness are known in the prior art and described for example in “Satas, Handbook of Pressure Sensitive Adhesives Technology”, Third Edition, (1999), pages 153 to 203. The degree of elastic and viscous component is typically characterized using the storage modulus (G′) and the loss modulus (G″), which may be determined via dynamic mechanical analysis (DMA), for example using a rheometer, as disclosed, for example, in WO 2015/189323. In the context of the present invention, an adhesive mass is preferably understood to have pressure-sensitive adhesiveness and hence to be a pressure-sensitive adhesive mass when, at a temperature of 23° C. in the deformation frequency range from 10⁰ to 10¹ rad/sec, G′ and G″ are each situated at least partly in the range from 10³ to 10⁷ Pa.

It can be considered an advantage of the application device according to the invention that the latter in terms of the chemical composition of the adhesive mass used in the adhesive layer is very flexible, so that substantially all adhesive masses known to the person skilled in the art can be used, and the person skilled in the art targets the selection of a suitable adhesive mass substantially based on the respective application requirements.

Apart from the adhesive layer, the adhesive elements disposed on the web-shaped separation material also comprise a carrier layer. In the context of the present invention, the term carrier layer is to be understood in a broad and functional sense, so that even comparatively thin coatings, for example a lacquer having a lacquer coating, are to be understood to be a carrier layer. The person skilled in the art understands specifically that the carrier layer in the context of the invention in most cases primarily has the task to reduce the stickiness of the side of the adhesive elements that faces away from the adhesive side, or to ideally entirely eliminate said stickiness. This serves in particular the purpose that the adhesive elements, which are transferred to the conveyor element with the adhesive layer facing downward, can be efficiently received on the non-sticky carrier layer by the application element, without adhesive bonding to the application element taking place. According to the opinion of the inventors, there will in practice accordingly expediently be at least a temporary coating which reduces the stickiness in the engagement region of the application element at least at the point of time of the application. However, in the latge majority of cases, the adhesive elements will possess a permanent carrier layer which is substantially permanently not sticky in such a way that a surface which has as little stickiness as possible advantageously permanently remains after the application of the adhesive elements on the substrate. In this context, the person skilled in the art understands that, while it would be at least theoretically conceivable to use adhesive elements which are sticky on both sides, i.e. adhesive elements which possess an adhesive layer on both sides of the carrier layer, such a process management is significantly less preferable with a view to a clean handling of the application procedure. Consequently, an application device according to the invention is preferable for the large majority of cases, wherein the side of the adhesive elements that faces away from the adhesive layer is formed by the carrier layer.

It can be considered an advantage of the application device according to the invention that the carrier layer can be produced from typical materials which are used for corresponding carrier layers in the field of adhesive technology. In this context, an example is an application device according to the invention, wherein the carrier layer comprises one or a plurality of materials which are selected from the group consisting of polyethylene, polypropylene, cyclic olefin copolymers, polyvinylchloride, polyester, ethylene vinyl alcohol, polyvinylidene chloride, polyvinylidene fluoride, polyacrylonitrile, polycarbonate, polyamide, polyethersulfone and polyimide, preferably is selected from the group consisting of polyethylene, polypropylene and polyethylene terephthalate, wherein the carrier layer preferably consists of these materials.

For example, so-called liners can be used as a web-shaped separation material on which the adhesive elements are disposed in the material tape. However, in terms of function, any web-shaped material having a reduced-adhesion surface can be used, wherein in terms of the reduced-adhesion surface the explanations disclosed hereunder pertaining to the reduced-adhesion surface of the conveyor element apply in an analogous manner, wherein the degree of the required reduction in addition can be adapted to the chemical nature of the adhesive mass and to the structural design embodiment of the dispensing edge in order to guarantee an efficient separation of the adhesive elements from the separation material. Web-shaped separation materials which have so-called siliconization and consequently have a reduced-adhesion surface are particularly preferable.

Preferable is an application device according to the invention, wherein the web-shaped separation material is a material with a reduced-adhesion surface, for example a liner. Particularly preferable is an application device according to the invention, wherein the web-shaped separation material is coated with a release layer, preferably with a silicone release layer, on the side that faces the adhesive elements, wherein the silicone release layer is preferably able to be produced by crosslinking a crosslinkable silicone system comprising one or a plurality of polysiloxanes.

The advantageous design embodiment of application devices according to the invention with a replaceable refill cassette advantageously permits comparatively short material tapes to be used without any excessive limitations in terms of the efficiency of the process management, because emptied material tapes can be replaced rapidly and efficiently so that the loss in terms of efficiency in comparison with very long material tapes is only minor. On the other hand, however, handling advantages are achieved on account of the short material tapes, in particular in terms of the weight of the cassette unit and correspondingly also in terms of the weight of the application device according to the invention, which has an advantageous effect particularly when the latter is used as an end effector. Against this background, an application device according to the invention is preferable, wherein the web-shaped separation material has a length in the range from 30 to 300 m, preferably in the range from 40 to 250 m, particularly preferably in the range from 50 to 200 m. Additionally or alternatively, an application device according to the invention is preferable, wherein the supply roll has a diameter of 500 mm or less, preferably 450 mm or less, particularly preferably 420 mm or less.

In application devices according to the invention, an adhesive element discharged from the cassette unit is transferred with the adhesive layer downwardly onto the conveyor element, from which the adhesive element can subsequently be received by the application element. Thus, the conveyor element serves the purpose to guide the adhesive element from the discharge region of the cassette unit to a receptacle region in which the application element can receive said adhesive element. According to the opinion of the inventors, very many different design embodiments of the conveyor element are theoretically conceivable, for example also design embodiments which are able to be operated exclusively discontinuously and utilize, for example, a movable slide on which the adhesive element is transferred close to the dispensing edge and which is subsequently displaced in the direction of the application element. However, according to the opinion of the inventors, a solution in which a continuously operable conveyor element, which can in particular be embodied as a revolving conveyor belt, is used is preferable for substantially all embodiments. A corresponding conveyor belt permits reliable and precisely controllable conveying of the adhesive elements and can in particular also be disposed in a fixed position in the base unit so that malfunction sources during the transfer of the adhesive elements from the cassette unit can be reduced. Preferable for substantially all embodiments is an application device according to the invention, wherein the conveyor element comprises a revolving conveyor belt. Additionally or alternatively preferable is an application device according to the invention, wherein the conveyor element is disposed in a fixed position in the base unit. For the purpose of receiving the adhesive elements by the application element in an ideally precise and controlled manner, it is advantageous according to the opinion of the inventors for many types of application elements to set discontinuous operation in use despite the continuous operability of the revolving conveyor belt, so that the conveyed adhesive element rests while being picked up by the application element. However, there are also design embodiments in which largely continuous conveying may be expedient, for example when the adhesive elements are to be transferred from the conveyor element to a continuously operating application element, for example in the form of an application roller.

The person skilled in the art understands that a conventional revolving conveyor belt, as could be used for an arrangement according to EP 3569534 A1, for example, is not readily suitable for use in application devices according to the invention. The reason therefor is that, as opposed to the teaching of the prior art, the adhesive elements are transferred to the conveyor element with the adhesive layer downward. In the absence of further measures, the adhesive elements would thus in many cases adhere completely or partially to the conveyor element and would no longer be able to be efficiently received by the application element in many cases, at least not without the risk that adhesive residues remain on the conveyor element, and the adhesive layer of the adhesive elements to be applied is correspondingly damaged. Moreover, the requirements set for the application element, or the bonding strength achievable therewith, when receiving the adhesive elements, would significantly also increase in this case.

For this reason, a conveyor element, the surface of which is designed in such a way that the adhesive elements, or the adhesive layers of the latter, exhibit reduced adhesion in relation to the surface is used in application devices according to the invention. A corresponding design embodiment can be readily implemented by the person skilled in the art knowing the invention, because they know the concept of reduced-adhesion surfaces from many other sectors of adhesive technology, in which this concept is regularly used in the context of typical liners, for example.

In practice it is difficult to specify absolute values for the acting forces and the required degree of the reduction in adhesion. The adhesion forces which can be tolerated between the adhesive elements and the reduced-adhesion surface of the conveyor element substantially depend on the physicochemical properties of the adhesive mass used, in particular of the cohesion of the latter, and on the bonding strength which the application element can briefly generate in relation to the carrier layer of the adhesive elements.

In practice, the choice of the adhesive mass used in the adhesive layer will in most cases depend on the application requirements which are set for the bonding strength in relation to the substrate to be adhesively bonded. The person skilled in the art, who has identified an adhesive mass suitable for the interaction with the substrate, can subsequently make a suitable selection for the material of the conveyor element, or for the coating of the latter, in relation to which the respective adhesive mass displays sufficiently minor adhesion enabling the adhesive element to be received by the application element. In this context, the inventors propose that the degree of adhesion of the adhesive element in relation to the reduced-adhesion surface is expediently to be specified relative to the adhesion of the adhesive element to the substrate to be adhesively bonded and/or relative to the connecting strength which the respective application element can form in relation to the adhesive element while receiving the adhesive element, because these interactions should both be larger than the adhesion of the adhesive element to the conveyor element in order to achieve the objective. Accordingly, an application device according to the invention is preferable, wherein the reduced-adhesion surface is conceived in such a way that the adhesion of the adhesive element to the reduced-adhesion surface is smaller, preferably by 80% or more, particularly preferably by 90% or more, most particularly preferably by 95% or more, than the adhesion of the adhesive element to the substrate to be adhesively bonded. Additionally or alternatively preferable is an application device according to the invention, wherein the reduced-adhesion surface is conceived in such a way that the adhesion of the adhesive element to the reduced-adhesion surface is smaller, preferably by 80% or more, particularly preferably by 90% or more, most particularly preferably by 95% or more, than the connection strength between the application element and the adhesive element when receiving the adhesive element by the application element.

In particular when the position of the adhesive elements on the conveyor element are also to be influenced by the use of guide elements and/or stopper elements, as disclosed hereunder, it is preferable to provide a particularly pronounced reduction in adhesion in order to permit easy displacing of the adhesive elements on the reduced-adhesion surface.

In order to obtain a reduced-adhesion surface, a coating of the surface of the conveyor element with siliconization, as is also used in many liners, for example, is particularly suitable according to the opinion of the inventors. Particularly preferable is an application device according to the invention, wherein the reduced-adhesion surface is coated with a release layer, preferably with a silicone release layer, wherein the silicone release layer is preferably able to be produced by crosslinking a crosslinkable silicone system comprising one or a plurality of polysiloxanes.

It can be considered an advantage of the method according to the invention that the adhesive elements are applied to the conveyor element with the adhesive layer downward, and consequently at least residual adhesion remains despite the reduced-adhesion surface, which results from the stickiness of the adhesive layer. Specifically in the case of stationary application devices according to the invention, which are not to be moved through space as part of a robotic arm, for example, providing an additional fixing mechanism for the adhesive elements on the conveyor element, such as a suction function, for example, can advantageously be dispensed with in many cases, in particular in conjunction with the fact that the application element ultimately carries out the final application step. By dispensing with such a suction function on the conveyor element, the complexity in terms of equipment can advantageously be significantly reduced because no pumps or the corresponding fluid lines have to be provided, for example. Preferable, in particular for largely stationary applications, is an application device according to the invention, wherein the conveyor element is not specified to additionally fix the adhesive elements disposed on the surface of the conveyor element by a vacuum acting through perforations in the surface of the conveyor element. Preferable in these cases is correspondingly also an application device according to the invention, wherein the conveyor element does not comprise any suction function for fixing the adhesive elements on the surface of the conveyor element. Preferable is consequently also an application device according to the invention, wherein the conveyor element does not comprise any device for generating a vacuum.

Despite the above-described possibility of being able to design the application device according to the invention in a structurally particularly simple manner, according to the opinion of the inventors it is nevertheless preferable for most application cases, however, to provide the application device according to the invention with a corresponding suction function on the conveyor element, as is able to be implemented with a suction belt, for example. The reason therefor is that, in particular when used on the end effector of a robotic arm, which potentially moves intensely, forces which could cause the adhesive elements to be released can act, despite the fact that these adhesive elements by way of the adhesive layer adhere to the conveyor element, because this adhesion is indeed consciously reduced as a consequence of the reduced-adhesion surface. Nevertheless, synergistic advantages are also obtained in this case, because the intensity of the suction function can be reduced on account of the additional adhesive action, and/or fixing of the adhesive elements on the surface of the conveyor element remains possible and falling off is prevented, at least in the absence of intense acceleration forces, even in the event of fluctuations in the output, or a brief failure of the suction function. Particularly preferable is an application device according to the invention, wherein the conveyor element is specified to additionally fix the adhesive elements disposed on the surface of the conveyor element by a vacuum acting through perforations in the surface of the conveyor element. Particularly preferable is correspondingly also an application device according to the invention, wherein the conveyor element comprises a suction function for fixing the adhesive elements on the surface of the conveyor element. Therefore, moreover particularly preferable is also an application device according to the invention, wherein the conveyor element comprises a device for generating a vacuum.

As disclosed above, discontinuous operation of the conveyor unit is preferable in most cases. The person skilled in the art understands that the conveying speed of the conveyor element should be adapted in some way to the guiding speed of the material tape in the guide assembly even in this discontinuous operation. In this context, the inventors propose that two different kinds of process management are in particular expedient for this purpose. In the first design embodiment, the conveying speed can substantially correspond to the guiding speed in the guide assembly, as a result of which a particularly good transfer from the dispensing edge onto the conveyor element can be guaranteed in most instances and an ideally continuous replenishment additionally becomes possible when using a continuously operating conveyor element. Preferable in this case is an application device according to the invention, wherein the conveyor element is specified to convey an adhesive element discharged by the cassette unit away from the cassette unit in the application device, wherein the conveying speed v_{F} relative to the cassette unit deviates from the guiding speed of the material tape v_{M} in the guide assembly preferably by 10% or less, particularly preferably by 5% or less, very particularly preferably by 1% or less, wherein the conveying speed v_{F} is particularly preferably not less than the guiding speed v_{M} of the material tape in the guide assembly.

However, the inventors have found that singularization of the adhesive elements on the conveyor element can advantageously take place as a result of a speed difference between the material tape and the conveyor element, when these adhesive elements are present disposed on the material tape for the purpose of an optimized utilization of space. For example, round punched blanks can be disposed on the material tape in a manner similar to a densest packing, so that an ideally large number of adhesive elements per area unit of the material tape can be achieved. In these cases, singularization of the adhesive elements is desirable in most instances in order to be able to achieve a greater precision when receiving the adhesive elements. Different speeds are likewise advantageous when the conveyor element has to bridge a relatively large distance to the application element, and it is desirable in terms of process management that only one adhesive element lies on the conveyor unit at any given time, for example. Therefore, for many cases preferable is an application device according to the invention, wherein the conveying speed of the conveyor element v_{F} is greater than the guiding speed of the material tape v_{M} in the guide assembly, wherein the conveying speed of the conveyor element is preferably at least 2*v_{M} or more, particularly preferably at least 3*v_{M} or more, most particularly preferably at least 4*v_{M} or more, particularly preferably at least 5*v_{M} or more.

It can be considered an advantage of the application device according to the invention that the latter is very flexible in terms of the application element used for the end application, so that rollers or similar can also be used, for example, wherein with a view to the practical implementation in the large majority of cases a requirement will be that the application element should be specified so as to be able to form a reversibly and non-destructively releasable connection with an adhesive element. In order to implement this functionality of the application element in such a way that the latter is specified to form a reversibly and non-destructively releasable connection with an adhesive element, the person skilled in the art can utilize various solutions known from the prior art.

The person skilled in the art understands that the above-described apparatus of the application element in a way to be able to form a reversibly and non-destructively releasable connection with an adhesive element does not require that the connection has to be unraveled by the absence of the connecting force, as would be achievable, for example, when switching off a magnetic field in the case of a magnetic connection or by switching off a suction function. Instead, it is also possible and even frequently particularly efficient in practice if the reversible and non-destructive release is performed counter to the acting forces that cause the connection. In the process, it can be utilized in particular that the adhesion of the adhesive elements to the substrate is in many cases significantly greater than the force causing the connection to the application element, so that the connection can take place, for example, counter to a vacuum has a suction effect when the application element is guided away from the substrate.

The reversibly and non-destructively releasable connection can at least in theory be established by a magnetic assembly, for example, which interacts with a magnetic carrier layer of the adhesive elements, for example, or can theoretically also be established by way of suction cups or a pressure-sensitive adhesive mass. Owing to the high reliability, the simple structural implementation and the longevity of such a solution, the use of a vacuum-based suction solution is however particularly preferable.

Particularly preferable according to the opinion of the inventors is an application element which comprises a piston assembly having a suction gripper disposed on a displaceable piston, because particularly precise and efficient application of the adhesive elements is possible with these application elements. In this case, the application element is oriented toward the conveyor element, and the controllable suction gripper is lowered onto the conveyor element by the displaceable piston, so as to contact the adhesive element situated thereon on the carrier layer by the suction gripper and to establish a connection in a reversible and non-destructive manner. By displacing the piston again, the adhesive element can be lifted from the conveyor element and be oriented in the direction of the substrate by means of the motion unit, before an application movement which contacts the adhesive layer to the substrate in such a way that the connection between the adhesive element and the application element can be unraveled takes place. Correspondingly preferable is an application device according to the invention, wherein the application element comprises a motion unit and a receptacle unit disposed on the motion unit, wherein the receptacle unit is specified to form a reversibly and non-destructively releasable connection with the carrier layer of the adhesive elements. Particularly preferable in this context is an application device according to the invention, wherein the receptacle unit comprises one or a plurality of controllable suction grippers, wherein the application device preferably comprises one or a plurality of vacuum pumps connected to the suction grippers. Additionally or alternatively preferable is an application device according to the invention, wherein the motion unit comprises a piston assembly having a cylinder and a piston displaceable in the cylinder, wherein the motion unit preferably comprises a rotary device for rotating the piston assembly, wherein the rotation axis preferably extends substantially parallel to the surface of the conveyor element.

In particularly preferred design embodiments, the application element can be embodied as a rotatable application element which comprises on both sides a corresponding displaceable piston and a suction gripper. In this way, the application element can be rotated about a rotation axis after receiving a first adhesive element, so as to orient the received adhesive element in the direction of a substrate onto which said adhesive element can be pressed by displacing the piston. In the meantime, an additional displaceable piston having a corresponding suction gripper on the rear side of the application element is ready to receive an additional adhesive element for the next application.

In a preferred alternative embodiment, an application of adhesive elements of different geometric shape and/or different dimensions is permitted on account of the different dimensioning of the suction grippers on the various ends of the motion unit. If two different cassette units with adhesive elements of different diameter are to be inserted into the cassette receptacle of the application device according to the invention, for example, in this embodiment an application of the adhesive elements of different dimensions can take place in that the receptacle face of the two suction grippers is selected so as to correspond to the two different diameters of the adhesive elements. This results in an application device according to the invention, by way of which a precise application of adhesive elements of different dimensions is enabled in a particularly efficient manner, without requiring any change of the application element. Particularly preferable is an application device according to the invention, wherein the application element comprises two or more receptacle units, wherein the receptacle units preferably have different dimensions. Based on this concept, application devices according to the invention are also preferable, wherein the application element comprises 3 or more, preferably 4 or more, particularly preferably 5 or more, receptacle units, wherein the receptacle units preferably have different dimensions.

As explained above, for ensuring a reliable transfer of the adhesive elements over the dispensing edge onto the conveyor element it is expedient to choose the spacing between these elements not to be excessive. In this context, the inventors have succeeded in specifying particularly suitable spacings for this purpose. Specifically preferable is an application device according to the invention, wherein the cassette unit is disposed in the base unit in such a way that the spacing between the end of the dispensing edge pointing onto the conveyor element and the conveyor element is 0.3*L_{K} or less, preferably 0.2*L_{K} or less, particularly preferably 0.1*L_{K} or less, most particularly preferably 0.05*L_{K} or less, where L_{K} is the mean length of the adhesive elements in the web direction of the material web.

Additionally or alternatively preferable is an application device according to the invention, wherein the cassette unit is disposed in the base unit in such a way that the spacing between the end of the dispensing edge pointing onto the conveyor element and the conveyor element is 10 mm or less, preferably 8 mm or less, particularly preferably 6 mm or less, most particularly preferably 4 mm or less.

In order to facilitate an ideally reliable transfer of the discharged adhesive element onto the conveyor element, the inventors propose that a contact pressure roller can moreover be provided in the transfer region, by way of which the adhesive element can additionally be guided when being transferred to the conveyor element and can be pressed onto the conveyor element. According to the opinion of the inventors, such a design embodiment is particularly advantageous when the conveyor element does not have a suction functionality and the adhesion of the adhesive elements is solely utilized for fixing the latter. Thus, preferable is an application device according to the invention, wherein the application device comprises one or a plurality of contact pressure rollers, preferably as part of the base unit, wherein the one, or the plurality of, contact pressure rollers are disposed opposite the surface of the conveyor element and are specified to press the adhesive element discharged by the cassette unit onto the surface of the conveyor element in order to improve the adhesion.

In particular for applications in which a high degree of precision is required, it can be expedient to verify the correct positioning of the adhesive elements on the conveyor element before said adhesive elements are received by the application element. The inventors propose that, for this purpose, the application device according to the invention can be equipped with sensor units, for example optical sensors, which can detect correct placing of the adhesive elements on the surface of the conveyor element. Therefore, preferable is an application device according to the invention, wherein the application device comprises one or a plurality of sensor units, preferably as part of the base unit, wherein the one, or the plurality of, sensor units are specified to detect the position of adhesive elements on the surface of the conveyor element, wherein controlling the application element preferably takes place as a function of data recorded by the one, or the plurality of, sensor units.

In addition or alternatively to providing detection units, the inventors propose that for guaranteeing a reliable and positionally accurate supply of the adhesive elements on the conveyor element to the application element, guide elements can moreover be provided, in particular baffle plates, for example in the form of a V which is open at the bottom, or in the form of two mutually offset guide elements. The reduced-adhesion surface of the conveyor element advantageously ensures that a displacement of the adhesive elements on the surface of the conveyor element is readily possible in many cases, so that the position of the adhesive elements transversely to their direction of movement, i.e. the conveying direction of the conveyor element, can in particular be adjusted. If the conveyor element is embodied with vacuum-based fixing, a displacement of the adhesive elements on the surface of the conveyor element by guide elements can be assisted by regions in which the contact pressure exerted by the suction function is reduced. Preferable is an application device according to the invention, wherein the application device comprises one or a plurality of guide elements, preferably as part of the base unit, wherein the one, or the plurality of, guide elements are specified to adjust the position of adhesive elements disposed on the conveyor element.

The inventors moreover propose, in addition or alternatively to repositioning the adhesive elements by guide elements, to provide a stopper element for fixing the position of the adhesive elements at a predetermined position of the conveyor element on the application device, which stopper element functions as a stopper, so to speak, and fixes the adhesive elements prior to being received by the application element. The stopper element here can additionally be specified to also perform repositioning of the adhesive elements transversely to the conveying direction, so that no separate guide elements are advantageously required. Specifically, repositioning of the adhesive elements as well as fixing can be performed in a simple manner by the reduced-adhesion surface of the conveyor element in that the stopper element blocks any movement of the adhesive element in the direction of movement of the conveyor element at a predefined position. When the person skilled in the art conceives the application device according to the invention in such a way that the adhesive elements can be relatively easily displaced on the reduced-adhesion surface, it is advantageously even possible to fix the position of the adhesive element when the conveyor belt continues to run and/or runs onward, so that the adhesive element is moved counter to the conveying direction on the reduced-adhesion surface. The inventors propose that the conveying direction of the conveyor element can be inverted, for example after the position of an adhesive element has been fixed by a stopper element even briefly, in order to offset the adhesive element from the stopper element and to obtain a greater precision when receiving the adhesive element by the application element, or to prevent any contamination of the stopper element with adhesive mass. Preferable is therefore an application device according to the invention, wherein the application device comprises a stopper element, preferably as part of the base unit, wherein the stopper element is specified to fix the position of adhesive elements disposed on the conveyor element in the conveying direction of the conveyor element, so that the adhesive elements are moved relative to the reduced-adhesion surface when moving the conveyor element.

In light of the above explanations, the person skilled in the art understands that the present invention also relates to the cassette unit particularly suitable for use of application devices according to the invention and to a complementary base unit for receiving this preferred cassette unit.

Accordingly, the invention moreover relates to a cassette unit for an application device according to the invention, comprising:
a1) a guide assembly comprising a supply roll and a take-up roll,
a2) a discharge region having a dispensing edge,
a3) a material tape comprising a multiplicity of adhesive elements having a carrier layer and an adhesive layer connected thereto, wherein the adhesive elements by way of the adhesive layer are disposed on a web-shaped separation material,
   wherein the cassette unit is specified in such a way that the material tape provided on the supply roll can be guided over the dispensing edge to the take-up roll in such a manner that the adhesive elements are separated from the separation material in the discharge region and are discharged from the cassette unit,
   wherein the supply roll and the take-up roll in the cassette unit are embodied as non-driven rolls, wherein the supply roll and/or the take-up roll comprise a central structured engagement recess,
   wherein the cassette unit is specified in such a way that when disposing the cassette unit in the cassette receptacle of a base unit, a form-fitting connection can be generated by way of the engagement of one or a plurality of connection elements of a drive unit of the base unit in the engagement recess of the supply roll and/or of the take-up roll, said form-fitting connection enabling the driving of the guide assembly by the drive unit.

Accordingly, the invention likewise relates to a base unit for an application device according to the invention, comprising:
b1) a cassette receptacle for receiving a cassette unit,
b2) a conveyor element having a reduced-adhesion surface, and
b3) an application element,
   wherein the base unit is specified to receive an adhesive element disposed on the conveyor element by the application element and to apply said adhesive element to a substrate to be adhesively bonded.

The invention moreover relates to a method for applying adhesive elements to substrates to be adhesively bonded by an application device according to the invention, comprising the method steps:
i) producing or providing a substrate to be adhesively bonded,
ii) guiding the material tape provided on the supply roll in the guide assembly over the dispensing edge for separating an adhesive element from the web-shaped separation material, and discharging the adhesive element from the cassette unit,
iii) transferring the discharged adhesive element having the adhesive layer onto the reduced-adhesion surface of the conveyor element,
iv) receiving the transferred adhesive element by the application element while forming a reversibly and non-destructively releasable connection between the application element and the carrier layer of the transferred adhesive element, and
V) applying the received adhesive element to the substrate to be adhesively bonded, and unraveling the connection between the application element and the carrier layer of the applied adhesive element.

Preferred here is a method according to the invention, wherein the position of adhesive elements disposed on the conveyor element is adjusted by one or a plurality of guide elements prior to the receiving in method step iv).

Preferable is a method according to the invention, wherein the substrate to be adhesively bonded is a vehicle component. Also preferable is a method according to the invention, wherein the substrate to be adhesively bonded comprises a recess, wherein the adhesive element is applied in order to at least partially, preferably substantially completely, close, preferably close in a fluid-tight manner, the recess.

Finally disclosed is also a method for supplying an application device according to the invention, comprising the method steps:
x) retrieving the first cassette unit which is disposed reversibly and non-destructively replaceably in the cassette receptacle of the base unit,
y) inserting a second cassette unit into the cassette receptacle of the base unit, and
z) refurbishing the first cassette unit by replacing the supply roll and the take-up roll in the first cassette unit by a replacements supply roll and a replacement take-up roll in order to obtain a refurbished cassette unit.

Preferred embodiments of the invention will be explained and described in more detail hereunder with reference to the appended figure in which:

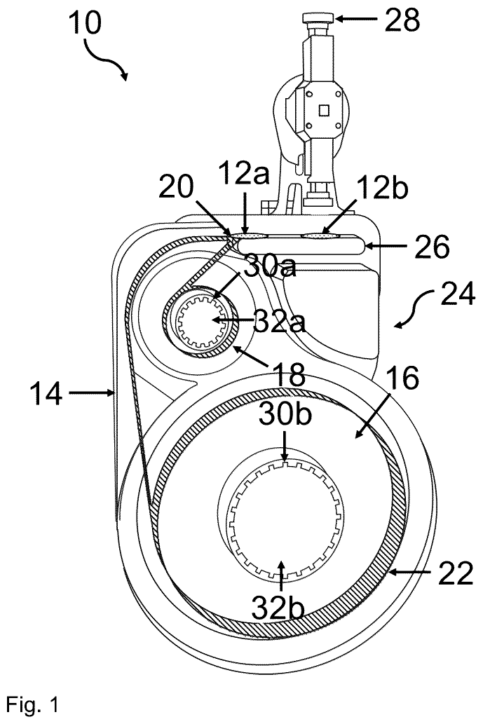

FIG. 1 shows a schematic illustration of an application device according to the invention in a preferred embodiment in a lateral view with a transparent housing of the cassette unit;

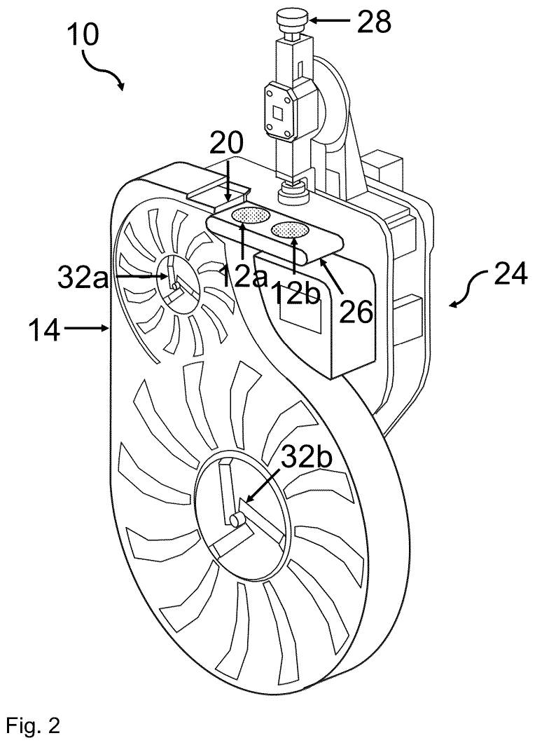

FIG. 2 shows a schematic illustration of the application device according to the invention of FIG. 1 in a perspective view with a closed housing of the cassette unit; and

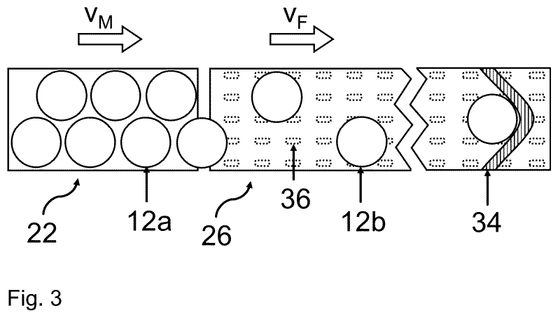

FIG. 3 shows a schematic illustration of a portion of a material tape and of a conveyor element of an application device according to the invention in a preferred embodiment in top view.

FIG. 1 shows a schematic illustration of an application device 10 according to the invention for applying adhesive elements 12a, 12b to substrates to be adhesively bonded in a lateral view with a transparent housing of the cassette unit 14 so that the interior of the cassette unit 14 is readily visible. In the example shown of FIG. 1, the application device 10 is designed as an end effector which can be fastened to a robotic arm, for example.

The application device 10 comprises a cassette unit 14, in the housing of which a stationary dispensing edge 20 and a guide assembly having a supply roll 16 and a take-up roll 18 are disposed. The dispensing edge 20, designed as a knife edge, here is disposed in the discharge region of the cassette unit 14 at a discharge opening of the housing, this identifying the point of the cassette unit 14 at which the adhesive elements 12a-b are transferred to the base unit 24. The cassette unit 14 moreover comprises a material tape 22 having a multiplicity of adhesive elements 12a-b which by way of their adhesive layer are disposed on a web-shaped separation material in such a way that the carrier layer of the adhesive elements 12a-b faces away from the web-shaped separation material. The material tape 22 is tensioned in the guide assembly between the supply roll 16, on which the material tape is initially provided, and the take-up roll 18, onto which the tape-shaped separation material is successively wound.

The cassette unit 14 is disposed in the cassette receptacle, provided for receiving the cassette unit 14, of the base unit 24 of the application device 10, into which the cassette unit 14 can be inserted in a reversible and non-destructively replaceable manner, this in the example shown of FIG. 1 being assisted by a magnetic connection mechanism. As a result, a consumed cassette unit 14 can be retrieved in order to freshly supply the application device 10 with material tape 22 and be replaced by a filled cassette unit 14.

The base unit 24 comprises a drive unit for driving the guide assembly, having two connection elements 32a, 32b and an electronic data processing device (not shown) for controlling the application device 10, in particular the drive unit. The drive unit serves to drive the guide assembly of the cassette unit 14, which in the example shown per se are in each case designed without a dedicated drive. For the necessary transmission of force, the supply roll 16 and the take-up roll 18 have in each case a central structured engagement recess 30a, 30b having a toothed structure, so that they can conjointly with the complementary connection elements 32a-b of the drive unit generate a form-fitting connection by way of which the guide assembly can be driven.

The base unit 24 moreover comprises an application element 28 and a conveyor element 26 which is in a fixed position and has a reduced-adhesion surface which is coated with a silicone release layer. The conveyor element 26 is designed as a revolving conveyor belt and in the example shown is disposed in the base unit 24 in such a way that the spacing between the end of the dispensing edge 20 facing the conveyor element 26 and the conveyor element 26 is approximately 3 mm. Proceeding from the basic arrangement shown, the base unit 24 can moreover have sensor units for detecting the position of the adhesive elements 12a-b on the surface of the conveyor element 26, and guide elements for adjusting the position of adhesive elements 12a-b disposed on the conveyor element 26 (not shown).

In the example shown, the application element 28 comprises a rotatable motion unit which has on both sides a piston assembly having a cylinder and a piston which is displaceable in the cylinder. Moreover, the application element 28 comprises on both sides in each case one controllable suction gripper which is disposed on the motion unit.

FIG. 2 shows the application device 10 illustrated in FIG. 1 in a perspective view with a closed housing of the cassette unit 14.

The application device 10 shown is particularly suitable for use in a method according to the invention for applying adhesive elements 12a-b to substrates to be adhesively bonded, for example vehicle components, so as to adhesively bond holes and other recesses in the latter, ideally in a fluid-tight manner. For this purpose, the cassette unit 14 is first equipped with the material tape 22 so that the latter can be unwound from the supply roll 16 in the guide assembly. Subsequently, the cassette unit 14 can be inserted into the cassette receptacle of the base unit 24 in such a manner that the connection elements 32a-b of the drive unit of the base unit 24 can engage in the corresponding toothed engagement recesses 30a, 30b of the supply roll 16 and of the take-up roll 18, wherein the connection elements 32a-b in the example shown are provided with movable elements by way of which the form fit is established.

The automated motion unit displaces the application device 10, which functions as an end effector, to its destination close to the recess to be bonded in the substrate. By activating the drive unit by way of the electronic data processing device, the supply roll 16 and the take-up roll 18 are set in rotation so that the material tape 22 having the adhesive elements 12a-b is unwound from the supply roll 16 and guided over the dispensing edge 20 to the take-up roll 18.

The web-shaped separation material, which on the side facing the adhesive elements 12a-b is coated with a silicone release layer, is deflected at the end of the dispensing edge 20 and guided onward to the take-up roll 18 so as to be wound up there. The deflection angle herein is at least 90°, but in the arrangement illustrated depends on the diameter of the take-up roll 18 and increases for larger diameters of take-up rolls. In the deflection, the adhesive elements 12a-b, which are embodied as punched blanks, for example, are separated from the web-shaped separation material of the material tape 22 at the end of the dispensing edge 20 and are transferred to the reduced-adhesion surface of the conveyor element 26 by the conveying movement of the material tape 22, so that the pressure-sensitive adhesive layer of the adhesive elements 12a-b rests on the reduced-adhesion surface of the conveyor element 26 and the carrier layer of the adhesive elements 12a-b faces upward in the direction of contact with the application element 28.

An adhesive element 12a-b thus discharged from the cassette unit 14 is transported away from the cassette unit 14 toward the application element 28 by the conveyor element 26, wherein the conveying speed v_{F} of the conveyor element 26 relative to the cassette unit 14 is, for example, at least double the guiding speed v_{M} of the material tape 22 in the guide assembly.

FIG. 3 visualizes how a singularization of the adhesive elements 12a-b can be achieved in a corresponding process management having a leading conveyor element 26 when transferring adhesive elements 12a from the material tape 22 to the conveyor element 26 in such a way that the adhesive elements 12b conveyed on the reduced-adhesion surface in the conveying direction have a larger mutual spacing than the adhesive elements 12a which are guided on the material tape 22 and were previously disposed in the manner of a densest pack.

The adhesion of the adhesive elements 12a-b to the reduced-adhesion surface in the examples shown in FIGS. 1 to 3 is substantially less than the adhesion of the adhesive element 12a-b to the substrate to be adhesively bonded, or than the connection strength between the application element 28 and the adhesive element 12a-b after receiving the adhesive element 12a-b. In the example shown of FIG. 3, the absolute value of the adhesion is chosen to be so low that a displacement of the adhesive elements 12a-b relative to the reduced-adhesion surface is possible without damaging the adhesive layer.

In the example shown of FIGS. 1 to 3, the adhesive elements 12a-b disposed on the surface of the conveyor element 26 are additionally fixed by a vacuum acting through a multiplicity of perforations 36 in the surface of the conveyor element 26 embodied as a suction belt.

For the improved precision in the positioning of the adhesive elements 12a-b on the conveyor element 26, the sensor units of the base unit 24 can detect the position of the adhesive elements 12a-b on the surface of the conveyor element 26. Subsequently, for example by way of guide elements of the base unit 24, the desired positions of the adhesive elements 12a-b on the conveyor element 26 can be adjusted, or corrected, as a function of the position data thus determined, so that the adhesive element 12a-b guided on the conveyor element 26 can be particularly precisely received by one of the two suction grippers of the application element 28, shown in FIG. 1. As shown in FIG. 3, a stopper element 34 can additionally improve the precision in the positioning of the adhesive element 12b guided on the conveyor element 26, in particular when receiving the adhesive element 12b by the application element 28, in that said stopper element blocks the adhesive element 12b from being conveyed in the conveying direction on the conveyor element 26 at a predefined position.

For receiving the adhesive element 12a-b, in the process, a vacuum between one of the suction grippers of the application element 28 and the adhesive element 12a-b to be applied is generated by a vacuum pump, so that a reversibly and non-destructively releasable connection between the carrier layer of the adhesive element 12a-b and the suction gripper is created. By rotating the suction grippers, for example about a rotation axis extending substantially parallel to the surface of the conveyor element 26, the adhesive element 12a-b by way of the adhesive layer can be applied to a substrate which is to be adhesively bonded and extends above the conveyor element 26, for example, in that the adhesive element 12a-b is pressed onto the substrate by the suction gripper. In the example shown of FIG. 1, an application is in principle possible at any position along the radius of the circle of the suction grippers, wherein the application takes place in particular at alignment angles in the range from 90° to 270°, proceeding from an angle of 0° when receiving the adhesive element 12a-b by the application element 28. In most cases, the reversibly and non-destructively releasable connection between the suction gripper and the adhesive element 12a-b will be unraveled by a movement of the application device 10, for example, because the adhesion of the adhesive element 12a-b to the substrate is greater than the force acting due to the vacuum.

### List of Reference Signs

10 Application device
12a-b Adhesive element
14 Cassette unit
16 Supply roll
18 Take-up roll
20 Dispensing edge
22 Material tape
24 Base unit
26 Conveyor element
28 Application element
30a-b Engagement recess
32a-b Connection elements
34 Stopper element
36 Perforation
v_{M} Guiding speed of the material tape
v_{F} Conveying speed of the conveyor element

1. An application device configured for applying adhesive elements to substrates to be adhesively bonded, the application device comprising:
a) a cassette unit comprising:
a1) a guide assembly comprising a supply roll and a take-up roll,
a2) a discharge region having a dispensing edge, and
a3) a material tape comprising a multiplicity of adhesive elements having a carrier layer and an adhesive layer connected thereto, wherein the adhesive elements with the adhesive layer are disposed on a web-shaped separation material,
wherein the cassette unit configured such that the material tape provided on the supply roll is guidable via the dispensing edge to the take-up roll such that the adhesive elements are separated from the separation material in the discharge region and discharged from the cassette unit, and
b) a base unit comprising:
b1) a cassette receptacle configured for receiving the cassette unit,
b2) a conveyor element having a reduced-adhesion surface, and
b3) an application element,
wherein the base unit is configured to receive an adhesive element disposed on the conveyor element by the application element and to apply the adhesive element to a substrate to be adhesively bonded, and
wherein the cassette unit is disposed in the cassette receptacle so as to be replaceable in a reversible and non-destructive manner, wherein the application device is configured such that an adhesive element, discharged from the cassette unit, with the adhesive layer is transferred to the reduced-adhesion surface of the conveyor element such that the transferred adhesive element can be received from the reduced-adhesion surface of the conveyor element by the application element and be applied to a substrate to be adhesively bonded.

2. The application device of claim 1, wherein the conveyor element is configured to additionally fix the adhesive elements disposed on the surface of the conveyor element by way of a vacuum acting through perforations in the surface of the conveyor element.

3. The application device of claim 1, wherein the conveyor element comprises a revolving conveyor belt.

4. The application device of claim 1, wherein the reduced-adhesion surface is coated with a release layer.

5. The application device of claim 1, wherein the reduced-adhesion surface is configured such that the adhesion of the adhesive element to the reduced-adhesion surface is less by 80% or more than the connecting strength between the application element and the adhesive element when receiving the adhesive element by the application element.

6. The application device of claim 1, wherein the application device comprises one or a plurality of contact pressure rollers, wherein the one or the plurality of contact pressure rollers are disposed opposite the surface of the conveyor element and are specified to press the adhesive element discharged by the cassette unit against the surface of the conveyor element to improve the adhesion.

7. The application device of claim 1, wherein the application device comprises one or a plurality of sensor units, wherein the one or the plurality of sensor units are specified to detect the position of adhesive elements on the surface of the conveyor element.

8. The application device of claim 1, wherein the application device comprises one or a plurality of guide elements, wherein the one or the plurality of guide elements are specified to adjust the position of adhesive elements disposed on the conveyor element, and/or wherein the application device comprises a stopper element, wherein the stopper element is specified to fix the position of adhesive elements disposed on the conveyor element in the conveying direction of the conveyor element such that, during a movement of the conveyor element, the adhesive elements are moved relative to the reduced-adhesion surface.

9. The application device of claim 1, wherein the supply roll and/or the take-up roll comprise a central structured engagement recess.

10. The application device of claim 9, wherein the base unit comprises a drive unit configured for driving the guide assembly of the cassette unit, wherein the drive unit comprises one or a plurality of connection elements disposed in the region of the cassette receptacle and are configured to engage in the engagement recess of the supply roll and/or of the take-up roll and to generate a form-fitting connection.

11. The application device of claim 10, wherein the cassette unit is disposed in the cassette receptacle such that the connection elements of the drive unit engage in a form-fitting manner in the engagement recess of the supply roll and/or of the take-up roll such that the guide assembly is drivable by the drive unit.

12. The application device of claim 1, wherein the dispensing edge is disposed in a fixed position in the cassette unit.

13. A cassette unit configured for the application device according to claim 1, the cassette unit comprising:
a1) a guide assembly comprising a supply roll and a take-up roll;
a2) a discharge region having a dispensing edge; and
a3) a material tape comprising a multiplicity of adhesive elements having a carrier layer and an adhesive layer connected thereto, wherein the adhesive elements with the adhesive layer are disposed on a web-shaped separation material,
wherein the cassette unit is configured such that the material tape provided on the supply roll is guidable via the dispensing edge to the take-up roll such that the adhesive elements are separated from the separation material in the discharge region and discharged from the cassette unit,
wherein the supply roll and the take-up roll in the cassette unit are embodied as non-driven rolls, wherein the supply roll and/or the take-up roll comprise a central structured engagement recess,
wherein the cassette unit is configured such that, when disposing the cassette unit in the cassette receptacle of a base unit, a form-fitting connection is generable by the engagement of one or a plurality of connection elements of a drive unit of the base unit in the engagement recess of the supply roll and/or of the take-up roll, the form-fitting connection enabling the driving of the guide assembly by the drive unit.

14. A base unit configured for the application device of claim 1, the base unit comprising:
b1) a cassette receptacle for receiving a cassette unit,
b2) a conveyor element having a reduced-adhesion surface, and
b3) an application element
wherein the base unit is specified to receive an adhesive element disposed on the conveyor element by the application element and to apply said adhesive element to a substrate to be adhesively bonded.

15. A method for applying adhesive elements to substrates to be adhesively bonded by the application device of claim 1, the method comprising:
i) producing or providing a substrate to be adhesively bonded,
ii) guiding the material tape provided on the supply roll in the guide assembly over the dispensing edge configured for separating an adhesive element from the web-shaped separation material, and discharging the adhesive element from the cassette unit,
iii) transferring the discharged adhesive element having the adhesive layer onto the reduced-adhesion surface of the conveyor element,
iv) receiving the transferred adhesive element by the application element while forming a reversibly and non-destructively releasable connection between the application element and the carrier layer of the transferred adhesive element, and
v) applying the received adhesive element to the substrate to be adhesively bonded, and unraveling the connection between the application element and the carrier layer of the applied adhesive element.
